(19) United States
(12) Patent Application Publication
(10) Pub. No.: US 2022/0415031 A1
(43) Pub. Date: Dec. 29, 2022

(54) INFORMATION PROCESSING DEVICE AND INFORMATION PROCESSING METHOD

(71) Applicant: Mitsubishi Electric Corporation, Tokyo (JP)

(72) Inventor: Michinori YOSHIDA, Tokyo (JP)

(73) Assignee: Mitsubishi Electric Corporation, Tokyo (JP)

(21) Appl. No.: 17/898,958

(22) Filed: Aug. 30, 2022

Related U.S. Application Data
(63) Continuation of application No. PCT/JP2020/013009, filed on Mar. 24, 2020.

(51) Int. Cl. G06V 10/80; G06T 7/13; G06T 7/521; G06T 7/20; G06T 7/70; G06V 20/58; G06V 10/70; G01S 13/86; G01S 7/41

(52) U.S. Cl. CPC G06V 10/803; G06T 7/13; G06T 7/521; G06T 7/20; G06T 7/70; G06V 20/58; G06V 10/70; G01S 13/865; G01S 13/867; G01S 7/41; G06T 2207/10028; G06V 2201/08; G06T 2207/30252

(57) ABSTRACT

Included are an object identification unit that identifies an identified object in an image; a mapping unit that generates a superimposed image by superimposing target points corresponding to ranging points and superimposing a rectangle surrounding the identified object to the image; an identical-object determination unit that specifies, in the superimposed image, two target points closest to the left and right line segments of the rectangle inside the rectangle; a depth addition unit that specifies, in a space, the positions of two edge points indicating the left and right edges of the identified object based on two ranging points corresponding to the two specified target points, and calculates two depth positions of two predetermined corresponding points different from the two edge points; and an overhead-view generation unit that generates an overhead view of the identified object from the positions of the two edge points and the two depth positions.

### CROSS-REFERENCE TO RELATED APPLICATION

This application is a continuation application of International Application No. PCT/JP2020/013009 having an international filing date of Mar. 24, 2020, which is hereby expressly incorporated by reference into the present application.

### BACKGROUND OF THE INVENTION

### 1. Field of the Invention

The disclosure relates to an information processing device and an information processing method.

### 2. Description of the Related Art

In order to produce autonomous driving systems and advanced driving support systems for vehicles, techniques have been developed to predict the future positions of movable objects, such as other vehicles existing in the periphery of a target vehicle.

Such techniques often use overhead views of the surroundings of a target vehicle viewed from above. For creating an overhead view, a method has been proposed in which semantic segmentation is performed on an image captured by a camera, depth is added to the result by using radar, and movement prediction is performed by creating an occupied grid map (for example, refer to Patent Literature 1).

Patent Literature 1: Japanese Patent Application Publication No. 2019-28861

### SUMMARY OF THE INVENTION

However, with the conventional technique, the use of an occupancy grid map for preparing the overhead view causes an increase in the data volume and throughput. This results in a loss of real-time processing.

Therefore, an object of one or more aspects of the disclosure is to enable the generation of an overhead view with low data volume and low throughput.

An information processing device according to an aspect of the disclosure includes: a processor to execute a program; and a memory to store the program which, when executed by the processor, performs processes of, identifying, as an identified object, a predetermined object in an image capturing a space, based on image data indicating the image; generating a superimposed image by superimposing a plurality of target points corresponding to a plurality of ranging points to the image at positions corresponding to the plurality of ranging points in the image, based on ranging data indicating distances to the plurality of ranging points in the space and by superimposing a rectangle surrounding the identified object to the image with reference to a result of identifying the identified object; specifying two target points closest to left and right line segments of the rectangle inside the rectangle out of the plurality of target points in the superimposed image; specifying, in the space, positions of feet of perpendicular lines extending from the two specified target points to closer of the right and left line segments as positions of two edge points indicating left and right edges of the identified object; calculating, in the space, two depth positions being positions of two predetermined corresponding points different from the two edge points; and generating an overhead view of the identified object by projecting the positions of the two edge points and the two depth positions onto a predetermined two-dimensional image.

An information processing method according to an aspect of the disclosure includes: identifying a predetermined object in an image capturing a space as an identified object, based on image data indicating the image; generating a superimposed image by superimposing a plurality of target points corresponding to a plurality of ranging points to the image at positions corresponding to the plurality of ranging points in the image, based on ranging data indicating distances to the plurality of ranging points in the space and by superimposing a rectangle surrounding the identified object to the image with reference to a result of identifying the identified object; specifying two target points closest to left and right line segments of the rectangle inside the rectangle out of the plurality of target points in the superimposed image; specifying, in the space, positions of feet of perpendicular lines extending from the two specified target points to closer of the right and left line segments as positions of two edge points indicating left and right edges of the identified object; calculating two depth positions in the space, the two depth positions being positions of two predetermined corresponding points different from the two edge points; and generating an overhead view of the identified object by projecting the positions of the two edge points and the two depth positions onto a predetermined two-dimensional image.

According to one or more aspects of the disclosure, an overhead view can be generated with low data volume and low throughput.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating the configuration of a movement prediction system;

FIG. 2 is a schematic diagram illustrating a usage example of a movement prediction system;

FIG. 3 is an overhead view for describing ranging points of a ranging device;

FIGS. 4A and 4B are perspective views for explaining ranging by a ranging device, image capturing by an image capture device, and an overhead view;

FIG. 5 is a plan view of an image captured by an image capture device;

FIG. 6 is a schematic diagram for describing a pinhole model;

FIG. 7 is a block diagram illustrating a hardware configuration example of a movement prediction device;

FIG. 8 is a flowchart illustrating processing by a movement prediction device; and

FIG. 9 is a flowchart illustrating depth calculation processing.

### DETAILED DESCRIPTION OF THE INVENTION

### Embodiments

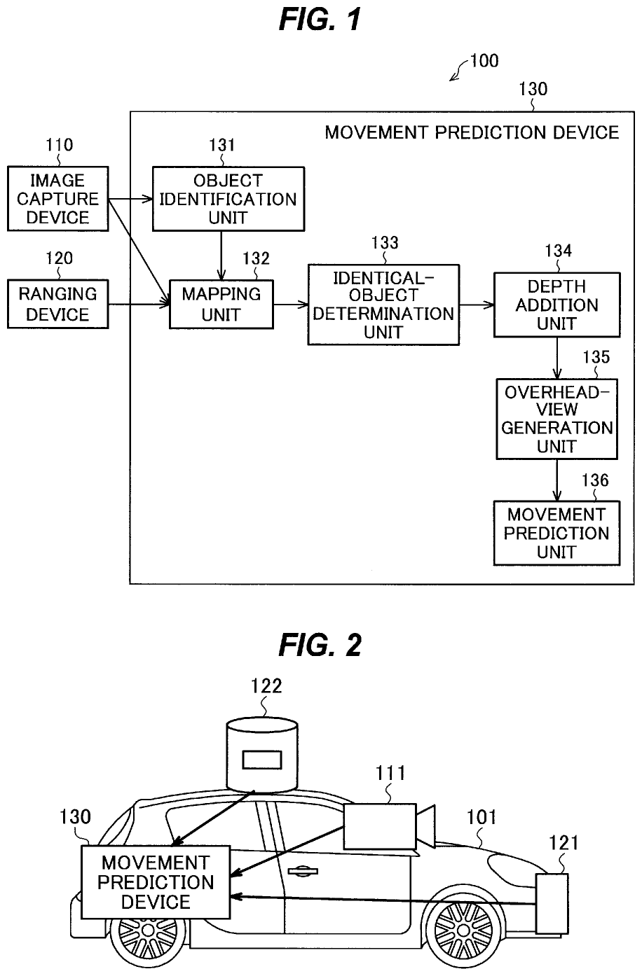

FIG. 1 is a block diagram schematically illustrating the configuration of a movement prediction system 100 including a movement prediction device 130 serving as an information processing device according to an embodiment.

FIG. 2 is a schematic diagram illustrating an arrangement example of the movement prediction system 100.

As illustrated in FIG. 1, the movement prediction system 100 includes an image capture device 110, a ranging device 120, and a movement prediction device 130.

The image capture device 110 captures an image of a space and generates image data indicating the captured image. The image capture device 110 feeds the image data to the movement prediction device 130.

The ranging device 120 measures the distances to multiple ranging points in the space and generates ranging data indicating the distances to the ranging points. The ranging device 120 feeds the ranging data to the movement prediction device 130.

The movement prediction system 100 is mounted on a vehicle 101, as illustrated in FIG. 2.

In FIG. 2, an example of the image capture device 110 is a camera 111 installed on the vehicle 101, serving as a sensor for acquiring two-dimensional images.

An example of the ranging device 120 is a millimeter-wave radar 121 and a laser sensor 122 mounted on the vehicle 101. As the ranging device 120, at least one of the millimeter-wave radar 121 and the laser sensor 122 may be mounted.

The image capture device 110, the ranging device 120, and the movement prediction device 130 are connected by a communication network, such as Ethernet (registered trademark) or controller area network (CAN).

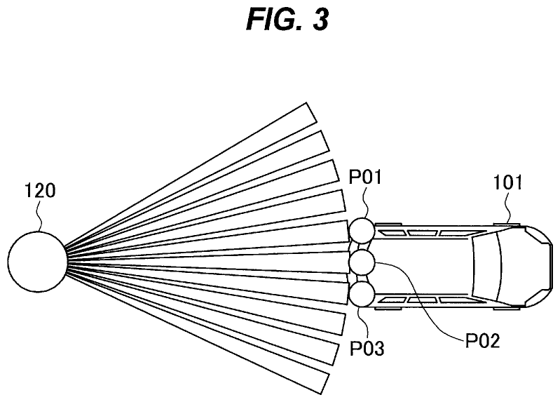

The ranging device 120, such as the millimeter-wave radar 121 or the laser sensor 122, will be described with reference to FIG. 3.

FIG. 3 is an overhead view for explaining ranging points of the ranging device 120.

Each of the lines extending radially to the right from the ranging device 120 is a light beam. The ranging device 120 measures the distance to the vehicle 101 on the basis of the time it takes for the light beam to hit the vehicle 101 and reflect back to the ranging device 120.

Points P01, P02, and P03 illustrated in FIG. 3 are ranging points at which the ranging device 120 measures the distances to the vehicle 101.

The resolution of the ranging device 120 is, for example, 0.1 degrees, which is a value determined in accordance with the specification of the ranging device 120 based on the pitch of the light beams extending radially. This resolution is sparser than that of the camera 111 functioning as the image capture device 110. For example, in FIG. 3, only three ranging points P01 to P03 are acquired for the vehicle 101.

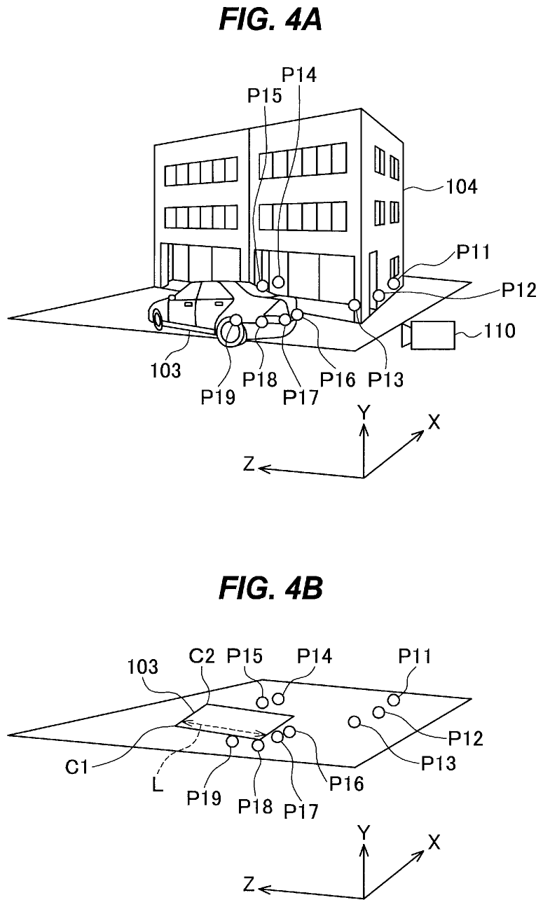

FIGS. 4A and 4B are perspective views for explaining ranging by the ranging device 120, image capturing by the image capture device 110, and an overhead view.

FIG. 4A is a perspective view for explaining ranging by the ranging device 120 and image capturing by the image capture device 110.

As illustrated in FIG. 4A, it is presumed that the image capture device 110 is installed so as to capture images in the forward direction of a mounted vehicle, which is a vehicle on which the image capture device 110 is mounted.

Points P11 to P19 illustrated in FIG. 4A are ranging points at which the ranging device 120 measured distances. Ranging points P11 to P19 are also disposed in the forward direction of the mounted vehicle.

As illustrated in FIG. 4A, the left-right direction of the space in which ranging and image capturing is performed is the X-axis, the vertical direction is the Y-axis, and the depth direction is the Z-axis. The Z-axis corresponds to the optical axis of the lens of the image capture device 110.

As illustrated in FIG. 4A, another vehicle 103 exists on the forward left side of the ranging device 120, and a building 104 exists on the forward right side of the ranging device 120.

FIG. 4B is a perspective overhead view from an oblique direction.

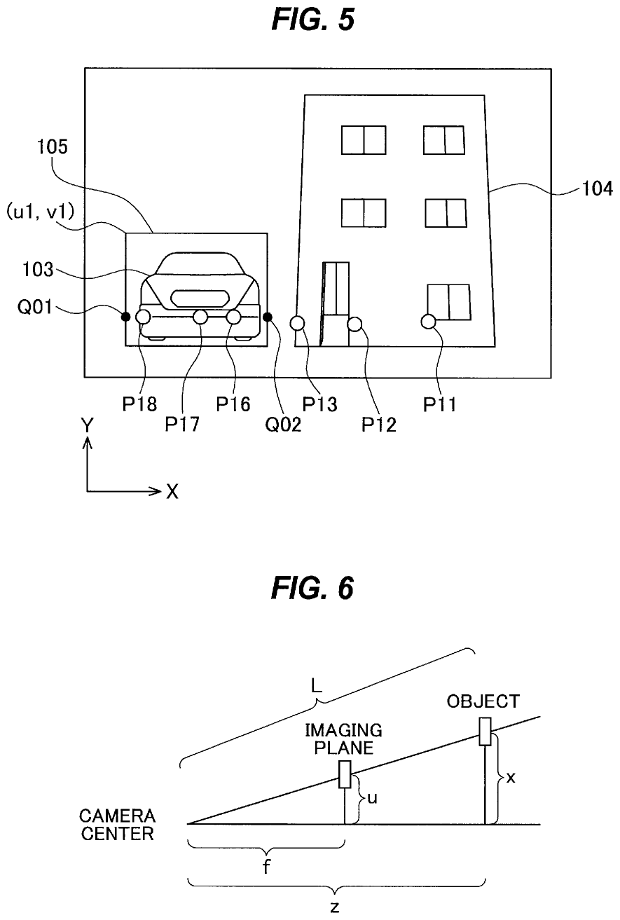

FIG. 5 is a plan view of an image captured by the image capture device 110 illustrated in FIG. 4A.

As illustrated in FIG. 5, the image is a two-dimensional image of two axes, the X-axis and the Y-axis.

The image captures the vehicle 103 on the left side and the building 104 on the right side.

In FIG. 5, the ranging points P11 to P13 and P16 to P18 are illustrated for the purpose of explanation, but these ranging points P11 to P13 and P16 to P18 are not captured in the actual image.

As illustrated in FIG. 5, the three ranging points P16 to P18 on the forward vehicle 103 constitute information that is sparser than the image.

Referring back to FIG. 1, the movement prediction device 130 includes an object identification unit 131, a mapping unit 132, an identical-object determination unit 133, a depth addition unit 134, an overhead-view generation unit 135, and a movement prediction unit 136.

The object identification unit 131 acquires image data indicating an image captured by the image capture device 110 and identifies a predetermined object in the image indicated by the image data. The object identified here is also referred to as an identified object. For example, the object identification unit 131 identifies an object in an image by machine learning. As machine learning, in particular, deep learning may be used, and, for example, a convolutional neural network (CNN) may be used. The object identification unit 131 feeds the identification result of the object to the mapping unit 132.

The mapping unit 132 acquires the ranging data generated by the ranging device 120, and superimposes multiple target points corresponding to multiple ranging points indicated by the ranging data onto an image indicated by the image data at positions corresponding to the ranging points. The mapping unit 132 refers to the identification result from the object identification unit 131 and, as illustrated in FIG. 5, superimposes a rectangular bounding box 105 onto the image indicated by the image data so as to surround the object (which is the vehicle 103, here) identified in the image.

As described above, the mapping unit 132 functions as a superimposition unit for the superimposition of the multiple target points and the bounding box 105. The image onto which the ranging points and the bounding box 105 are superimposed is also referred to as a superimposed image. The size of the bounding box 105 is determined, for example, through image recognition by the CNN method. In image recognition, the bounding box 105 has a predetermined size larger than the object identified in the image by a predetermined margin.

Specifically, the mapping unit 132 maps the ranging points acquired by the ranging device 120 and the bounding box 105 onto the image indicated by the image data. The image captured by the image capture device 110 and the positions detected by the ranging device 120 are calibrated in advance. For example, the amount of shift and the amount of rotation for aligning a predetermined axis of the image capture device 110 with a predetermined axis of the ranging device 120 are known. The axis of the ranging device 120 is converted to the coordinates of the center, which is the axis of the image capture device 110, on the basis of the amount of shift and the amount of rotation.

For example, the pinhole model illustrated in FIG. 6 is used for the mapping of the ranging points.

The pinhole model illustrated in FIG. 6 indicates a figure viewed from above, and the projection onto the imaging plane is obtained by the following equation (1).

u=fX/Z (1)

where u is the pixel value in the horizontal axis direction, f is the f-value of the camera 111 used as the image capture device 110, X is the position of an actual object on the horizontal axis, and Z is the position of the object in the depth direction. Note that the position in the vertical direction of the image can also be obtained by simply changing X to the position (Y) in the vertical direction (Y-axis). In this way, the ranging points are projected onto the image, and target points are superimposed at the positions of the projection.

The identical-object determination unit 133 illustrated in FIG. 1 is a target-point specifying unit for specifying, in the superimposed image, two target points corresponding to two ranging points for measuring the distance to the identified object at two positions closest to the right and left end portions of the identified object.

For example, the identical-object determination unit 133 specifies, in the superimposed image, two target points closest to the left and right line segments of the bounding box 105 out of the target points existing inside the bounding box 105.

A case in which a target point close to the left line segment of the bounding box 105 is specified in the image illustrated in FIG. 5 will be explained as an example.

When the pixel value of the upper left corner of the bounding box 105 is (u1, v1), the target point having the pixel value (u3, v3) corresponding to the ranging point P18 is the target point closest to the line segment represented by the value u1. As an example of such a technique, a target point having the smallest absolute value of the difference between the value u1 and the horizontal axis value may be specified out of the target points inside the bounding box 105. As another example, a target point having the smallest distance to the left line segment of the bounding box 105 may be specified.

The target point corresponding to the ranging point P16 closest to the right line segment of the bounding box 105 can also be specified in the same manner as described above. The pixel value of the target point corresponding to the ranging point P16 is (u4, u4).

The depth addition unit 134 illustrated in FIG. 1 calculates depth positions in the space that are the positions of two predetermined corresponding points different from the two ranging points specified by the identical-object determination unit 133.

For example, the depth addition unit 134 calculates, in the space, the tilt of a straight line connecting the two ranging points specified by the identical-object determination unit 133 relative to an axis extending in the left-right direction of the superimposed image (here, the X-axis) on the basis of the distances to the two ranging points, and calculates the depth positions by tiling a corresponding line segment, which is a line segment corresponding to the length of the identified object in a direction perpendicular to the straight line, in the left-right direction of the axis in accordance with the calculated tilt and determining the positions of the ends of the corresponding line segment.

Here, it is presumed that the two corresponding points correspond to the two ranging points specified by the identical-object determination unit 133 on the plane opposite to the plane of the identified object captured by the image capture device 110.

Specifically, the depth addition unit 134 reprojects the target points close to the right and left edges in the superimposed image onto the actual object position. It is presumed that the target point (u3, v3) corresponding to the ranging point P16 close to the left edge is measured at the actual position (X3, Y3, Z3). Here, the values Z, f, and u illustrated in FIG. 6 are known, and it is necessary to obtain the X-axis value. The X-axis value can be obtained by the following equation (2).

X=uZ/f (2)

As a result, as illustrated in FIG. 5, the actual position of the edge point Q01 on the line segment closer to the target point corresponding to the ranging point P18 between the left and right line segments of the bounding box 105, at a height that is the same as that of the target point corresponding to the ranging point P18 is determined as (X1, Z3), and the position of the left edge of the vehicle 103 in the overhead view illustrated in FIG. 4B is determined.

Similar to the above, the actual position of the edge point Q2 at a height that is the points same as that of the target point corresponding to the ranging point P16 close to the right edge is determined as (X2, Z4).

The depth addition unit 134 then obtains the angle between the X-axis and a straight line connecting the edge points Q01 and Q02.

In the example illustrated in FIG. 5, the angle between the X-axis and the straight line connecting the edge points Q01 and Q02 is obtained by the following equation (3).

θ=cos⁻¹{\sqrt{(X2−X1)²+(Z4−Z3)²}/{square root over ((X2−X1)²+(Z3²)}} (3)

When the depth of an object recognized through image recognition can be measured, the measured value may be used, but when the depth of the recognized object cannot be measured, the depth needs to be saved in advance as a fixed value, which is a predetermined value. It is necessary to determine the depth L of the vehicle as illustrated in FIG. 4B, for example, by setting the depth of the vehicle to 4.5 m.

For example, if the coordinates of the position C1 of the end portion of the vehicle 103 in FIG. 4B on the left edge in the depth direction are (X5, Z5), the coordinate values can be obtained by the following equations (4) and (5).

XS=L cos(90−θ)+X1 (4)

Z5=L sin(90−θ)+Z3 (5)

Similarly, if the coordinates of the position C2 of the end portion of the vehicle 103 on the right edge in the depth direction are (X6, Z6), the coordinate values can be obtained by the following equations (6) and (7).

X6=L cos(90−θ)+X2 (6)

Z6=L sin(90−θ)+Z4 (7)

As described above, the depth addition unit 134 specifies, in the space, the positions of the feet of the perpendicular lines extending from the two target points specified by the identical-object determination unit 133 to the closest of the right and left line segments of the bounding box 105, as the positions of the two edge points Q01 and Q02 indicating the right and left edges of the identified object. The depth addition unit 134 can calculate depth positions C1 and C2, in the space, which are the positions of two predetermined corresponding points different from the two edge points Q01 and Q02.

The depth addition unit 134 calculates, in the space, the tilt of the straight line connecting the two ranging points P16 and P18 relative to the axis along the left-right direction in the space (here, the X-axis), and calculates, as depth positions, the positions of the ends of the corresponding line segment, which corresponds to the length of the identified object in the direction perpendicular to the straight line, with the corresponding line segment tilting in the left-right direction relative to the axis in accordance with the calculated tilt.

In this way, the depth addition unit 134 can specify the coordinates of the four corners (here, the edge point Q01, the edge point Q02, the position C1, and the position C2) of the object (here, the vehicle 103) recognized in the image.

The overhead-view generation unit 135 illustrated in FIG. 1 projects the positions of the two edge points Q01 and Q02 and the positions C1 and C2 of the two corresponding points onto a predetermined two-dimensional image to generate an overhead view showing the identified object.

Here, the overhead-view generation unit 135 generates the overhead view with the coordinates of the four corners of the identified object specified by the depth addition unit 134 and the remaining target points.

Specifically, the overhead-view generation unit 135 specifies the target points not inside any of the bounding boxes after all target points inside all bounding boxes corresponding to all objects recognized in the images captured by the image capture device 110 have been processed by the depth addition unit 134.

The target points specified here are the target points of objects that exist but are not recognized in the image. The overhead-view generation unit 135 projects ranging points corresponding to these target points onto the overhead view. An example of a technique for this includes a method of reducing the height direction to zero. Another example of the technique is a method of calculating the intersections of the overhead view and lines extending perpendicular to the overhead view from the ranging points corresponding to the target points. Through this processing, an overhead view is completed showing an image corresponding to a portion of the object inside the bounding box and points corresponding to the remaining ranging points. For example, FIG. 4B is a perspective view of the completed overhead view.

The movement prediction unit 136 illustrated in FIG. 1 predicts the movement of the identified object included in the overhead view. For example, the movement prediction unit 136 can predict the movement of the identified object by machine learning. For example, CNN may be used. The movement prediction unit 136 receives input of an overhead view of the current time point and outputs an overhead view of the time to be predicted. As a result, a future overhead view can be obtained, and the movement of the identified object can be predicted.

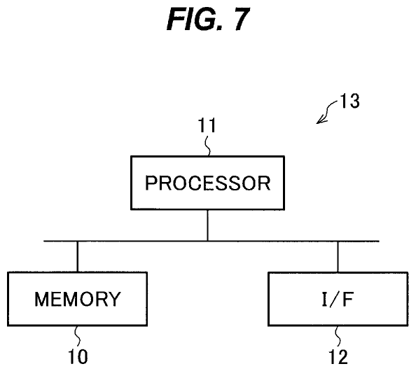

FIG. 7 is a block diagram illustrating a hardware configuration example of the movement prediction device 130.

The movement prediction device 130 can be implemented by a computer 13 including a memory 10, a processor 11, such as a central processing unit (CPU), that executes the programs stored in the memory 10, and an interface (I/F) 12 for connecting the image capture device 110 and the ranging device 120. Such programs may be provided via a network or may be recorded and provided on a recording medium. That is, such programs may be provided as, for example, program products.

The I/F 12 functions as an image input unit for receiving input of image data from the image capture device 110 and a ranging-point input unit for receiving input of ranging-point data indicating ranging points from the ranging device 120.

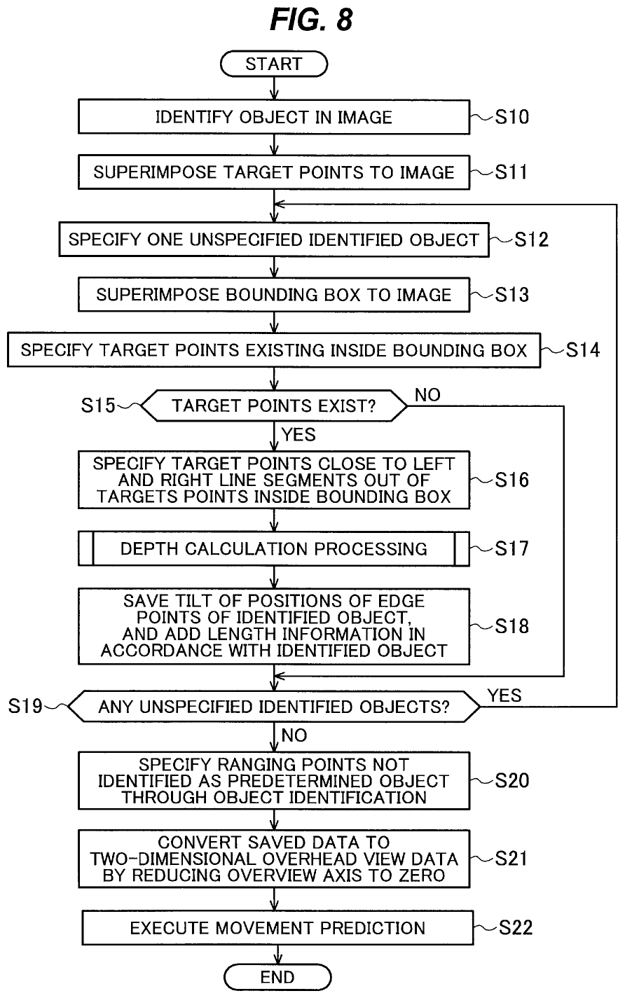

FIG. 8 is a flowchart illustrating the processing by the movement prediction device 130.

First, the object identification unit 131 acquires image data indicating an image captured by the image capture device 110 and identifies an object in the image indicated by the image data (step S10).

Next, the mapping unit 132 acquires ranging-point data indicating the ranging points detected by the ranging device 120 and superimposes target points corresponding to the ranging points indicated by the ranging-point data to the image captured by the image capture device 110 (step S11).

The mapping unit 132 then specifies one identified object in the object identification result obtained in step S10 (step S12). The identified object is an object identified through the object identification performed in step S10.

The mapping unit 132 then reflects the identification result obtained in step S10 on the image captured by the image capture device 110 (step S13). Here, the object identification unit 131 superimposes a bounding box so as to surround the identified object specified in step S12.

Next, the identical-object determination unit 133 specifies the target points existing inside the bounding box in the superposed image to which the target points and the bounding box are superimposed (step S14).

The identical-object determination unit 133 then determines whether or not target points have been specified in step S14 (step S15). If target points are specified (Yes in step S15), the processing proceeds to step S16; if target point are not specified (No in step S15), the processing proceeds to step S19.

In step S16, the identical-object determination unit 133 specifies two target points closest to the left and right line segments of the bounding box out of the target points specified in step S14.

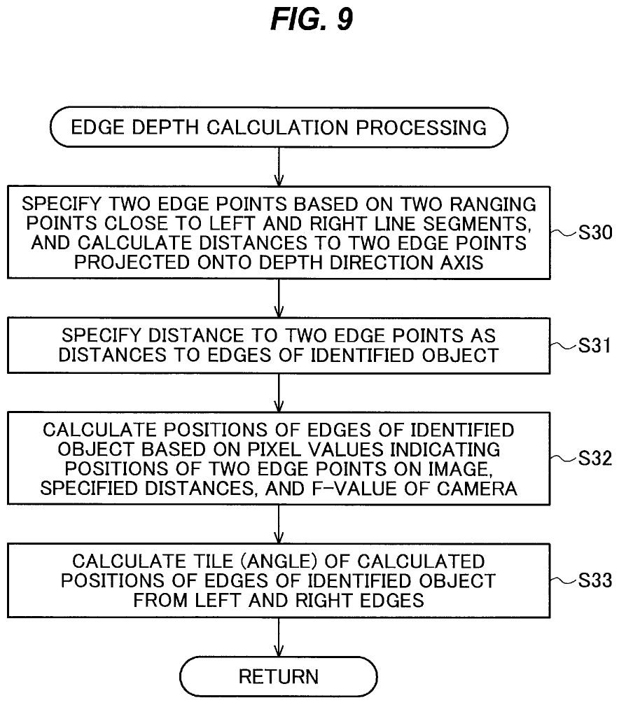

Next, the depth addition unit 134 calculates the positions of two edge points from the two target points specified in step S16 and executes depth calculation processing for adding depth to the two edge points (step S17). The depth calculation processing will be explained in detail with reference to FIG. 9.

The depth addition unit 134 then uses the above-described equations (4) to (7) to calculate the positions of the edge points in the depth direction of the identified object from the tilt of the positions of the edge points of the identified object calculated in step S17, specifies the coordinates of the four corners of the identified object, and temporarily stores the coordinates (step S18).

Next, the mapping unit 132 determines whether or not any unspecified identified objects exist in the identified objects indicated by the object identification result obtained in step S10 (step S19). If an unspecified identified object exists (Yes in step S19), the processing returns to step S12 to specify one identified object in the unspecified identified objects. If no unspecified identified objects exist (No in step S19), the processing proceeds to step S20.

In step S20, the overhead-view generation unit 135 specifies the ranging points that were not identified as an object in step S10.

The overhead-view generation unit 135 then generates an overhead view with the coordinates of the four corners of the identified object temporarily stored in the depth addition unit 134 and the ranging point specified in step S20 (step S21).

Next, the movement prediction unit 136 predicts the movement of the moving object in the overhead view (step S22).

FIG. 9 is a flowchart illustrating depth calculation processing executed by the depth addition unit 134.

The depth addition unit 134 specifies two edge points based on two ranging points closest to the left and right line segments of the bounding box and calculates the distances to the respective edge points when the two edge points are projected in the depth direction (here, the Z-axis) (step S30).

The depth addition unit 134 then specifies the distances of the two edge points calculated in step S30 as the distances to the edges of an identified object (step S31).

The depth addition unit 134 then uses the equation (2) to calculate the X-axis values of the edges of the identified object on the basis of the pixel values indicating the positions of the left and right edges in the image information, the distances specified in step S31, and the f-value of the camera (step S32).

The depth addition unit 134 then uses the equation (3) to calculate the tilt of the positions of the edges of the identified object calculated from the two edge points (step S33).

As described above, according to the present embodiment, it is possible to reduce throughput by fusing multiple sensors and utilizing some features of an image instead of the entire image, so that the system can be operated in real-time.

### DESCRIPTION OF REFERENCE CHARACTERS

100 movement prediction system; 110 image capture device; 120 ranging device; 130 movement prediction device; 131 object-identification unit; 132 mapping unit; 133 identical-object determination unit; 134 depth addition unit; 135 overhead-view generation unit; 136 movement prediction unit.

What is claimed is:

1. An information processing device comprising:
a processor to execute a program; and
a memory to store the program which, when executed by the processor, performs processes of,
identifying, as an identified object, a predetermined object in an image capturing a space, based on image data indicating the image;
generating a superimposed image by superimposing a plurality of target points corresponding to a plurality of ranging points to the image at positions corresponding to the plurality of ranging points in the image, based on ranging data indicating distances to the plurality of ranging points in the space and by superimposing a rectangle surrounding the identified object to the image with reference to a result of identifying the identified object;
specifying two target points closest to left and right line segments of the rectangle inside the rectangle out of the plurality of target points in the superimposed image;
specifying, in the space, positions of feet of perpendicular lines extending from the two specified target points to closer of the right and left line segments as positions of two edge points indicating left and right edges of the identified object;
calculating, in the space, two depth positions being positions of two predetermined corresponding points different from the two edge points; and
generating an overhead view of the identified object by projecting the positions of the two edge points and the two depth positions onto a predetermined two-dimensional image.

2. The information processing device according to claim 1, wherein the processor calculates, in the space, a tilt of a straight line connecting the two ranging points relative to an axis along a left-right direction in the space, and calculates positions of the ends of a corresponding line segment tilting in the left-right direction relative to the axis in accordance with the calculated tilt as the depth positions, the corresponding line segment being a line segment corresponding to a length of the identified object in a direction perpendicular to the straight line.

3. The information processing device according to claim 2, wherein the length is predetermined.

4. The information processing device according to claim 1, wherein the processor identifies the identified object in the image by machine learning.

5. The information processing device according to claim 2, wherein the processor identifies the identified object in the image by machine learning.

6. The information processing device according to claim 3, wherein the processor identifies the identified object in the image by machine learning.

7. The information processing device according to claim 1, wherein the processor further predicts movement of the identified object by using the overhead view.

8. The information processing device according to claim 2, wherein the processor further predicts movement of the identified object by using the overhead view.

9. The information processing device according to claim 3, wherein the processor further predicts movement of the identified object by using the overhead view.

10. The information processing device according to claim 4, wherein the processor further predicts movement of the identified object by using the overhead view.

11. The information processing device according to claim 5, wherein the processor further predicts movement of the identified object by using the overhead view.

12. The information processing device according to claim 6, wherein the processor further predicts movement of the identified object by using the overhead view.

13. The information processing device according to claim 7, wherein the processor predicts the movement by machine learning.

14. The information processing device according to claim 8, wherein the processor predicts the movement by machine learning.

15. The information processing device according to claim 9, wherein the processor predicts the movement by machine learning.

16. The information processing device according to claim 10, wherein the processor predicts the movement by machine learning.

17. The information processing device according to claim 11, wherein the processor predicts the movement by machine learning.

18. The information processing device according to claim 12, wherein the processor predicts the movement by machine learning.

19. An information processing method comprising:
Identifying, as an identified object, a predetermined object in an image capturing a space, based on image data indicating the image;
generating a superimposed image by superimposing a plurality of target points corresponding to a plurality of ranging points to the image at positions corresponding to the plurality of ranging points in the image, based on ranging data indicating distances to the plurality of ranging points in the space and by superimposing a rectangle surrounding the identified object to the image with reference to a result of identifying the identified object;
specifying two target points closest to left and right line segments of the rectangle inside the rectangle out of the plurality of target points in the superimposed image;
specifying, in the space, positions of feet of perpendicular lines extending from the two specified target points to closer of the right and left line segments as positions of two edge points indicating left and right edges of the identified object;
calculating two depth positions in the space, the two depth positions being positions of two predetermined corresponding points different from the two edge points; and
generating an overhead view of the identified object by projecting the positions of the two edge points and the two depth positions onto a predetermined two-dimensional image.
